(19) United States
(12) Patent Application Publication
(10) Pub. No.: US 2025/0023752 A1
(43) Pub. Date: Jan. 16, 2025

(54) Low-Cost Event History for Monitoring Device Users

(71) Applicant: Google LLC, Mountain View, CA (US)

(72) Inventors: Yu-sheng Chen, Dublin, CA (US); John-Ashton Allen, Oakland, CA (US); Ankit Mohan, San Carlos, CA (US)

(73) Assignee: Google LLC, Mountain View, CA (US)

(21) Appl. No.: 18/486,596

(22) Filed: Oct. 13, 2023

Related U.S. Application Data
(60) Provisional application No. 63/512,862, filed on Jul. 10, 2023.

(51) Int. Cl. H04L 12/28; H04N 7/18

(52) U.S. Cl. CPC H04L 12/2803; H04N 7/183; H04N 7/188; H04L 2012/2841

(57) ABSTRACT

This document describes systems and techniques directed at low-cost event history for monitoring device users. In aspects, the techniques include selectively uploading images captured at a monitoring device, such as a doorbell camera or a surveillance camera, to a client device (e.g., a smartphone) or a remote device (e.g., a server). In so doing, the described systems and techniques reduce data transmission and storage overhead.

### RELATED APPLICATION

This application claims priority to U.S. Provisional Application No. 63/512,862, filed Jul. 10, 2023, the disclosure of which is hereby incorporated by reference in its entirety.

### SUMMARY

This document describes systems and techniques directed at low-cost event history for monitoring device users. In aspects, the techniques include the utilization of on-device processors to selectively upload images captured at a monitoring device, such as a doorbell camera or a surveillance camera. The selected images can then be stored and accessed at a client device (e.g., a smartphone) and/or a remote device (e.g., a server). In so doing, the described systems and techniques reduce data transmission and storage overhead, as well as processing consumption at the client device and/or the remote device.

In one example, a monitoring device includes a wireless communication component configured to transmit and receive wireless communications. One or more sensors are configured to sense data of an environment surrounding the monitoring device. The monitoring device includes one or more processors and a data storage device configured to store at least portions of the sensed data and one or more programs to be executed by the one or more processors to direct the processor in performing various operations. Based on the sensed data, a trigger condition is detected that is indicative of a start of an event occurring within the environment surrounding the monitoring device. Based on the detected trigger condition, a generation of a notification at a client device associated with a monitoring device user is initiated. First media is selected from the sensed data based on a first temporal proximity to the detection of the trigger condition. The first media is transmitted to the client device associated with the monitoring device user. The notification and the first media are viewable and/or hearable at the client device. An interest score is determined at a plurality of time intervals of the sensed data, the plurality of time intervals extending from the start of the event to an end of the event. At the end of the event, second media is selected from the sensed data, the second media being selected based on a second temporal proximity to a respective time interval of the plurality of time intervals associated with a highest interest score determined during the event. The second media is uploaded to a remote device separate from the client device and is viewable and/or hearable at the client device via access to the remote device.

This Summary is provided to introduce systems and techniques directed at low-cost event history for monitoring device users as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques directed at low-cost event history for monitoring device users are described in this document with reference to the following drawings. The same numbers are used throughout the drawings to reference like features and components:

FIG. 1 is a schematic diagram of a system in which selected images collected by a monitoring device are transmitted to a user over a network or are stored in a remote device;

FIGS. 2 and 3 are schematic views of an event log derived from data sensed by the monitoring device and a rolling buffer of captured images;

FIG. 4 is a schematic diagram of the system of FIG. 1 as used to transmit the selected images of FIGS. 2 and 3 to a user or to a remote device;

FIGS. 5A-5D are screen displays from a client device that receives data or enables access to images and other data in the systems of FIGS. 1 and 4;

FIG. 6 is a schematic view of the event log and rolling buffer of FIGS. 2 and 3 after the selected images have been transmitted to the user or to a remote device; and

FIG. 7 is a flow diagram of an example method of sending selected images from a monitoring device to a user or a remote device.

### DETAILED DESCRIPTION

### Overview

Monitoring devices, such as doorbell cameras and other surveillance devices, enable property owners (e.g., smarthome owners) to monitor events occurring at or near their homes or properties from anywhere in the world. Such devices are capable of streaming video and/or audio data to mobile telephones, for example, enabling real-time monitoring. However, transmitting and/or storing countless gigabytes of video and/or audio data consumes a great deal of transmission bandwidth and digital storage. In aggregate, such transmission bandwidth and digital storage may present huge costs (e.g., financial expenses, processing power, electrical power expenditure).

While some users of monitoring devices choose to pay for subscriptions to store and access some or all video and/or audio data, other users of monitoring devices may choose not to pay for subscriptions to such services, limiting their storage of and access to video and/or audio data. In general, the payment of subscription fees by monitoring device users subsidizes costs associated with transmission bandwidth and data storage. Thus, limiting monitoring device users storage and access to video and/or audio data is often the result of minimizing non-subsidized costs associated with transmission bandwidth and data storage. However, if monitoring device users are limited in their access to video and/or audio data captured by their monitoring devices, then these users may be dissatisfied with their monitoring devices and their services. Thus, it is desirable to provide low-cost access to video and/or audio data that is captured by monitoring devices of monitoring device users. As described herein, the term “monitoring device users” may include monitoring device owners who choose not to pay for subscription services, as well as owners who choose to pay some fees for limited services. The term “monitoring device users” may further include, in some implementations, monitoring device owners of all subscription service tiers, including those who choose to pay for full subscription services.

In aspects, by taking advantage of on-device processing resources, monitoring devices can selectively upload captured images (e.g., representative images) to a client device and/or a remote device for storage. Through the on-device processing and image selection, the techniques and systems described herein can reduce transmission bandwidth and data storage associated with non-subscription, including low-fee subscription, services.

### Example Systems

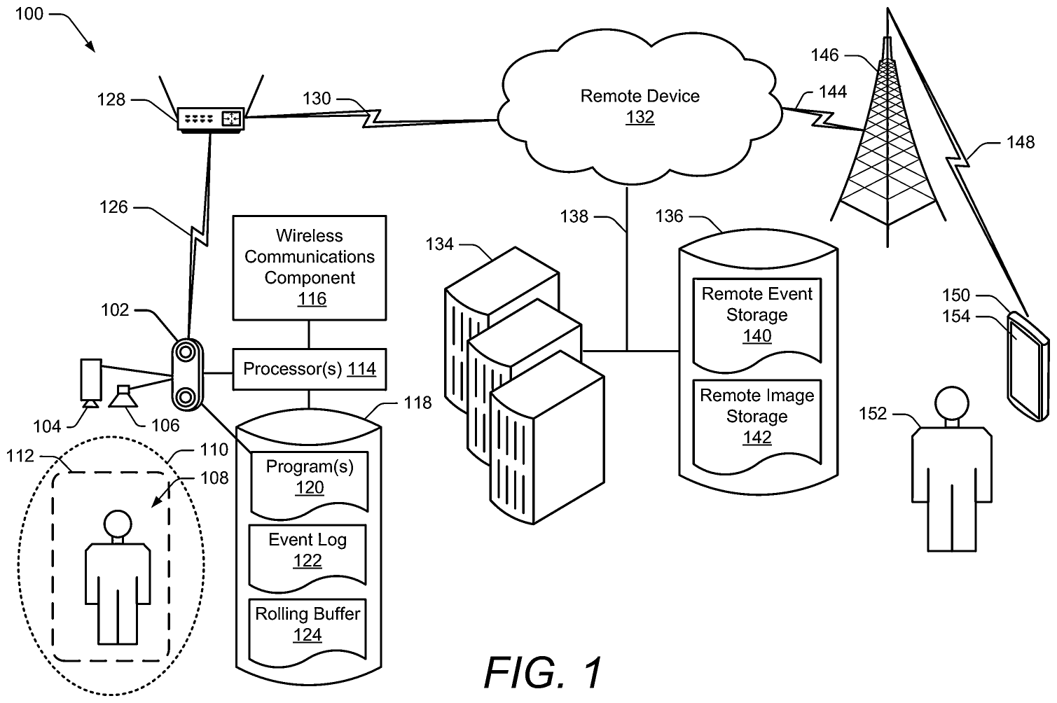

FIG. 1 illustrates a system 100 that includes a monitoring device 102. The monitoring device 102 may be implemented as, for example only and not by way of limitation, any one of a surveillance camera, an electronic doorbell, or the like. The monitoring device 102 includes, or is operatively coupled to, one or more sensors (e.g., an image sensor 104 and a microphone 106) configured to sense data 108 (e.g., a motion detection involving a person) of an environment 110 (represented in dotted lines in FIG. 1) proximate to where the monitoring device 102 and/or the one or more sensors are situated. In implementations, the monitoring device 102 and the environment 110 may be regarded as part of a “smarthome” environment. In various implementations, the one or more sensors include an image sensor 104 configured to capture image data of a scene 112 (represented in dashed lines in FIG. 1), such as images or video, and a microphone 106 configured to capture audio data (e.g., an audio event such as honking, yelling, barking) from the environment 110 surrounding the monitoring device 102. Although not illustrated, the one or more sensors may further include motion sensors, infrared sensors, radar sensors, lidar sensors, accelerometers, barometric sensors, and so on. Further, although the data sensed 108 is represented by a detection of a person, it will be appreciated that automobiles, animals, and other objects, as well as sounds or other phenomenon, may also, or separately, be included in the sensed data 108.

The monitoring device 102 includes one or more processors 114 operatively coupled with the one or more sensors, a wireless communications component 116, and a data storage device 118. The one or more processors 114 are operated according to one or more programs 120 stored in the data storage device 118. The one or more programs 120 may include an operating system, one or more application programs, one or more communications program, or other software (not specifically shown in FIG. 1). The wireless communications component 116 may include a Wi-Fi communications system (e.g., an IEEE 802.01-type communications system), a Bluetooth communications system, or some other type of wireless communications device.

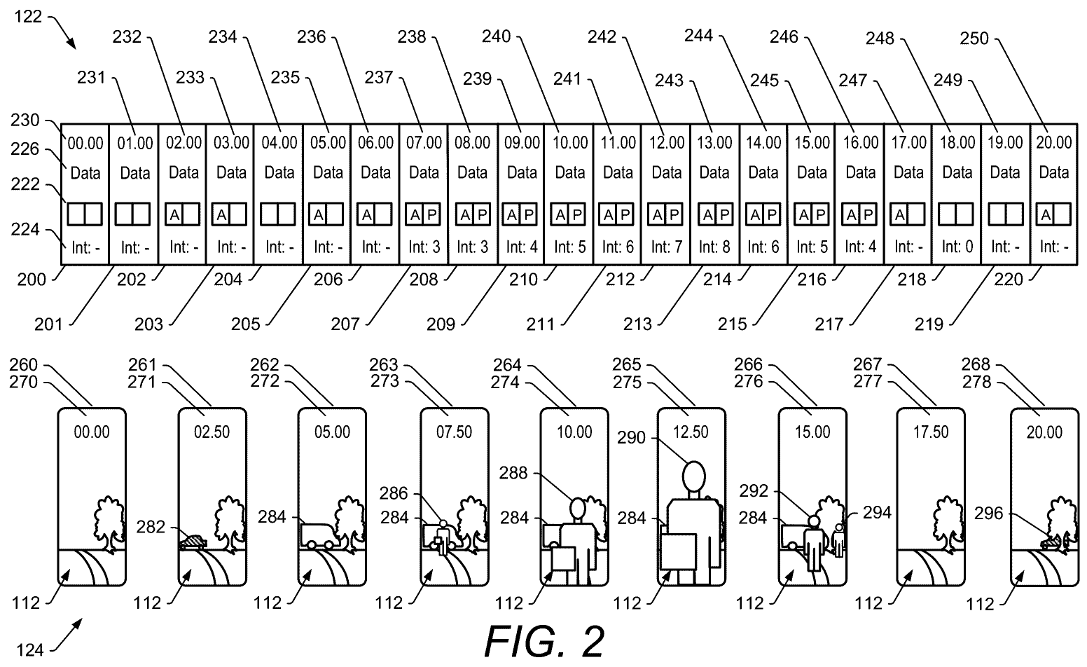

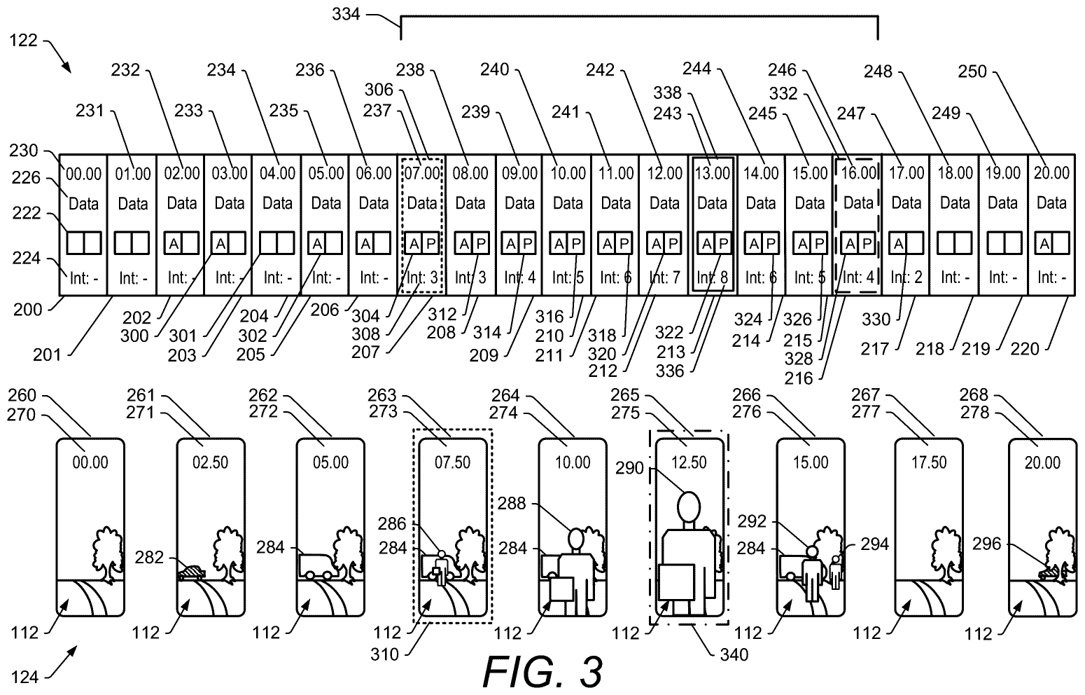

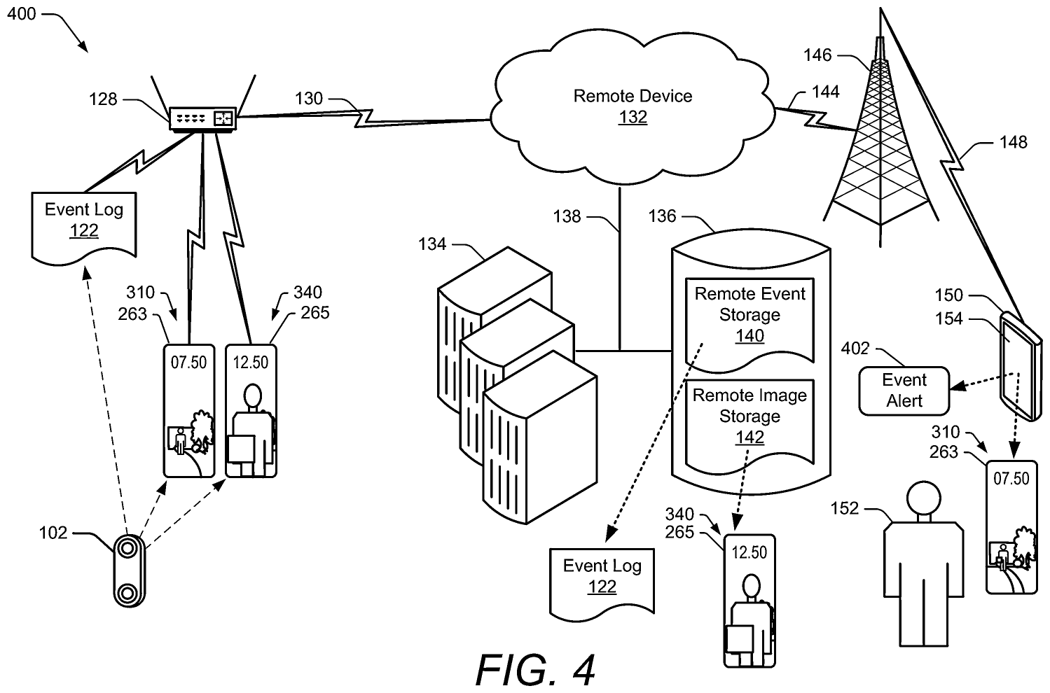

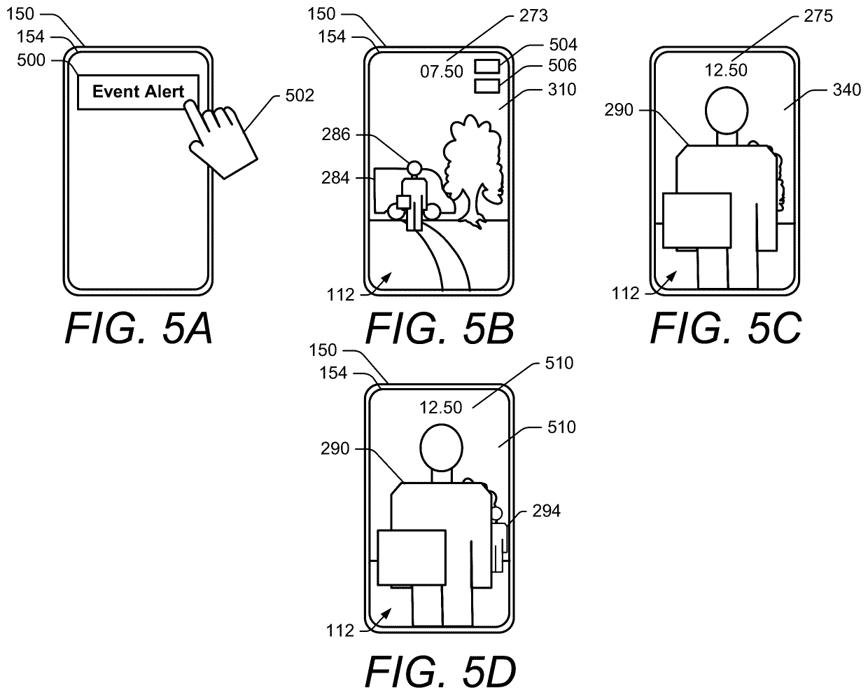

The data storage device 118, in addition to storing the one or more programs 120, can also be configured to store other data, including an event log 122 and a rolling buffer 124 configured to temporarily store images captured by the image sensor 104 at the direction of the one or more processors 114. Contents and use of the event log 122 and the rolling buffer 124 are further described below with reference to FIGS. 2 and 3. The one or more processors 114 are configured to receive and/or retrieve data from the data storage device 118, including the event log 122 and/or media (e.g., images, audio) from the rolling buffer 124, and direct the wireless communications device 116 to upload or otherwise transmit the data via a transmission link 126 to a communications hub 128, such as a router or an access point. The type of data being uploaded or transmitted may determine a destination to which the data is sent via the communications hub 128, as further described below with reference to FIGS. 4 and 5A-5D.

The communications hub 128 uses a communications link 130, such as a wired or wireless Internet connection, to communicate with a remote device 132. The remote device 132 may include a cloud-based server or other remote system configured to receive, process, store, and/or transmit data. The remote device 132 includes remote processing systems 134 and remote data storage 136 communicatively coupled by a data channel 138. The remote data storage 136 includes remote event storage 140 that may receive the event log 122 transmitted by the monitoring device 102. The remote data storage 136 also includes remote image storage 142 that may receive selected images from the rolling buffer 124 transmitted by the monitoring device 102, as described below with reference to FIGS. 2-5D.

The remote device 132 communicates via a communications link 144 with a data network 146 (represented by an antenna tower in FIG. 1), such as a wireless mobile telephone and data network. The data network 146 supports communication via a communications link 148 with a client device 150, such as a mobile telephone or portable computing device. Via the client device 150, selected images and/or other event data are transmitted to and/or are accessible by a user 152 via a display 154 of the client device 150 to provide the user 152 with information about events detected by the monitoring device 102.

FIG. 2 illustrates an example event log 122 derived from the sensed data 108 collected by the one or more sensors, as well as an example rolling buffer 124 maintained at the monitoring device 102 to store a plurality of images 260-268 captured by the image sensor 104. The event log 122 includes elements or records 200-220 that hold data derived from and representative of the sensed data 108 captured by the one or more sensors at a sequence of times 230-250, respectively. The records 200-220 may be logged at each of a number of time intervals.

In the example of FIGS. 2 and 3, each of the records 200-220 in the event log 122 may include four types of data. The record 200, for example, includes a time 230 at which the data stored in the record 200 is recorded. The record 200 may include a conditions field 222 to store indicia of one or more conditions identified in the sensed data 108 captured by the one or more sensors. The conditions identified may include, for example, automobiles, persons, packages, animals, or other objects detectable by the image sensor 104 or sounds, such as fire alarms, car alarms, animal sounds, voices, or other sounds detectable by the microphone 106 included in the sensed data 108.

For purposes of the example of FIGS. 2 and 3, the monitoring device 102 is configured (e.g., by user settings, machine-learned user preferences, or preset settings made by the original manufacturer or other provider of the monitoring device 102) to identify and register one or more conditions in the sensed data 108. For example, as illustrated in FIG. 2, the monitoring device 102 is configured to identify two conditions: automobiles (represented by an “A”) and persons (represented by a “P”). As is understood by those skilled in the art of computer vision, conditions such as automobiles or persons may be automatically detected from visual data by recognizing size, shape, and/or movement of such objects using understood computer vision techniques. However, in the foregoing example, only automobiles and persons are expressly logged in the conditions field 222 of the event log 122 of FIGS. 2 and 3.

Based on further settings of the monitoring device 102, the monitoring device 102 may be configured to only regard certain conditions as trigger conditions that will result in the user 152 receiving an alert via the client device 150. For example, when the monitoring device 102 is situated along a busy road, the user 152 may choose not to have the monitoring device 102 generate alerts based on the presence of automobiles. Thus, while the monitoring device 102 may detect the presence of automobiles and/or may log the presence of the automobile in the conditions field 222, this condition is not regarded as a trigger condition that will result in an alert being generated. By contrast, the monitoring device 102 may be configured to recognize that the presence of one or more persons is a trigger condition that will result in an alert being sent to the user 152. Whether conditions in the sensed data 108 are regarded as a trigger condition also may be based on contextual information, such as a user's pet walking within the environment 110.

Trigger conditions may also be based on audio data, including loud noises, alarms, or other sounds, whereas common sounds such as car engine noises or birds singing may not be considered trigger conditions. Although conditions and trigger conditions may be derived from audio data captured by the microphone 106, the example of FIGS. 2 and 3 only deals with visual conditions.

In various implementations, operating modes of the monitoring device 102 may change in response to detecting a trigger condition in the sensed data 108. For example, before a trigger condition is detected, the image sensor 104 of the monitoring device 102 may operate in a low-power mode in which the image sensor 104 is inactive or collects image data at a reduced frame rate and/or a reduced resolution. Upon detecting a trigger condition, the one or more processors 114 may instruct the image sensor 104 to operate at a higher frame rate and/or capture image data at a higher resolution. In additional examples, as described below, after a trigger condition is detected in the sensed data 108, the one or more processors 114 may calculate a score based on an activity and/or a proximity of the trigger condition detected in the sensed data 108.

The monitoring device 102 is also configured to generate an interest score 224 (identified as “Int” in FIGS. 2 and 3) based on at least one of contextual information (e.g., planned events, a time of day, a duration of an event), types of detected objects, a confidence of detected objects or events, or a machine-learned technique for key frame detection (e.g., a representative frame which includes the whole facts of the video collection). In additional implementations, users and/or machine-learned techniques may adjust an interest score sensitivity. For example, the one or more processors 114 determine a high value interest score 224 at a particular time interval when contextual information indicates that an unknown person is close to the monitoring device 102, moving more vigorously, or manifests other characteristics that differentiate the trigger event from ordinary situations. In an implementation in which the sensed data 108 includes various audio data and sounds may be regarded as be a trigger condition, volume of sounds or particular types of sounds may influence the interest score.

In one example, a person moving towards the monitoring device 102 or is moving hastily may be considered to be of more interest than a person who is farther away from the monitoring device 102 and/or who is not moving hastily. Thus, the monitoring device 102 may generate a relatively high interest score 224 for the person moving towards the monitoring device 102 but may generate a relatively low interest score for a person further away from the monitoring device 102. In various implementations, such as in the example of FIGS. 2 and 3, the monitoring device 102 does not generate an interest score 224 until a trigger condition is detected (e.g., a condition in the condition field 222).

The records 200-220 in the event log 216 may also store other data 226 derived from the one or more sensors. For example, the other data 226 may include details and information relating to the sensed data, such as a speed of an object, a volume of sounds, a time of day, a number of detected objects, facial recognition results, person recognition results, an activity of the detected object(s), a location on the property, or other such details. The rolling buffer 124 includes images 260-268 captured at time intervals 270-278, respectively.

In the example of FIGS. 2 and 3, the monitoring device 102 may be a doorbell camera positioned at a front door of a home and facing a street on which the home is located. As shown in image 260, the scene 112 captured by the image sensor 104 of the monitoring device 102 shows a view of a front walkway through a yard where no automobiles, persons, animals, or other animate objects are present. By contrast, in the image 261, an automobile 282 appears. In the image 262, a delivery truck 284 appears. In the image 263, a person close to the delivery truck 284 appears. In the image 264, a person approaching the front door 288 appears. In the image 265, a person at the front door 290 appears. In the image 266, a person between the front door and the delivery truck 284 appears, along with another person 294 appearing in the background. The person close to the delivery truck 284, the person approaching the front door 288, the person at the front door 290, and the person between the front door and the delivery truck 284 may be the same person appearing at different locations in the images 263-266, and the monitoring device 102 may be able to determine that this is the same person (e.g., using path detection and/or person detection). In the image 267, the scene 112 is devoid of conditions tracked by the monitoring device 102 (e.g., the scene includes no detected objects or motion), which may be indicative of an end of an event. In some implementations, the monitoring device 102 can wait for a preset amount of time with no detected objects, movement, or sounds before determining an end of an event. In the image 268, another vehicle 296 appears. Derivation and use of the event log 122 based on sensed data 108 of these conditions are described with reference to FIG. 3.

For the sake of illustration, the times 230-250 associated with the records 200-220 shows the records 200-220 being logged in the event log 122 at intervals of once every second from 00.00 through 20.00, where 20.00 represents 20 seconds after the start of the event log 00.00. The time intervals 270-278 at which the images 260-268 in the rolling buffer 124 are captured is once every 2.5 seconds. In actuality, records may be logged in the event log 122 many times per second, such as 10 to 50 times per second. Similarly, images may be captured into the rolling buffer 124 several times per second, such as 5 to 10 times per second. The times 230-250 associated with the records 200-220 and the time intervals 270-278 at which the images 260-268 are captured are selected to provide an example of an event with different conditions appearing in or departing from the view of the monitoring device 102 to provide an example how various implementations of the disclosed systems and techniques operate. The operational parameters are used only for example and should not be regarded as restricting operation of the systems described herein.

FIG. 3 shows the response of the monitoring device 102 to conditions appearing in the sensed data 108 represented in the event log 122 and the rolling buffer 124. For purposes of the example, automobiles and persons are the only conditions that are tracked, although it will be appreciated that animals, packages, and other objects also may constitute conditions detectable by the monitoring device 102. Again, for purposes of illustration, the monitoring device 102 is configured to issue an alert to the user only when one or more persons are detected by the monitoring device 102; thus, detection of an automobile alone will not result in an alert being generated (e.g., a trigger condition not detected).

At time 00.00 230 represented in record 200, no conditions are present in the condition field 224 because no automobiles or persons are present in the sensed data 108. (This corresponds with the image 260 captured at the time 00.00 270 showing no automobiles or persons, only the background 112.) By contrast, for example, at time 03:00 233 of the record 303, an automobile is detected and logged (with an “A”) in a condition field 300 for the record 303. (The automobile 282 appears in image 261 at time 02.50 271.) At time 04.00 234 of the record 204, once again no conditions are logged in the condition field 301. At time 05.00 235 of the record 205, a condition field 302 registers presence of an automobile (reflected by the image 262 captured at time 05.00 272 showing a delivery truck 284). However, because no persons are present, no person conditions are logged in the condition fields 300, 301, and 302, thus, no alert is sent to the user 152.

However, at time 07.00 237 of the record 207, a condition field 304 registers presence of a person (logged with a “P”) which is recognized as a trigger condition that signals the beginning of an event and, thus, will result in initiating a generation of an alert (e.g., a wirelessly transmitted notification) at the client device 150 for the user 152. Thus, the time 237 of the record 207 is determined to be a start time 306 (as represented by a dotted-line outline surrounding the record 207 in FIG. 3) of an event. Because the detected presence of a person in the sensed data 108 indicates that an event is occurring, the monitoring device 102 generates an interest score 308, which for the record 207 is “3.” The value of “3” is a non-zero value to indicate that the interest score 308 indicates that there is some activity associated with the record 207 as a result of detecting a person within the sensed data 108 of the environment 110. However, values of the interest scores in the example of FIGS. 2 and 3 are selected only to signify relative values of the interest scores based on the conditions associated with the respective records and should not be regarded as meaningful representations of interest scores that may actually be generated. As previously described, in various implementations, the monitoring device 102 generates an interest score based on detecting an event unto a determination of a completion of the event, as described below. However, in other implementations, the monitoring device 102 may generate an interest score for all records or any records for which any monitored condition is detected.

As part of generating the alert, the monitoring device 102 retrieves media. For example, the monitoring device retrieves, from the rolling buffer 124, an image captured in a first temporal proximity to the time 7.00 237 of the record 207, which was determined to be the start time 306 of the event. In this case, the image 263 captured at time 07.50 273 is the image captured in closest temporal proximity to the start time 306, the time 7.00 237 of the record 207. In various implementations, the image in temporal proximity may be selected as the next image after the time at which the trigger condition was detected as long as that image does not precede the time when the trigger condition was detected. The image 263 shows the delivery truck 284 and the person 286, the presence of whom was registered in the condition field 304. The image 263 retrieved from the rolling buffer 124 is identified as a first image 310 (as represented by the dotted-line outline in FIG. 3) representing the start of an event. The first image 310 will be transmitted to a user 152 via the client device 150 to inform the user 152 of the start of the event, as further described below with reference to FIGS. 4 and 5A-5B.

Condition fields 304, 312, 314, 316, 318, 320, 322, 324, 326, and 328 of records 207 through 216, respectively, between times 07.00 237 and time 16.00 246, all indicate that a condition in the form of a person is detected in the sensed data 108 captured by the monitoring device 102. (This is consistent with the images 264-266 showing at least one person, including the person 286 near the delivery truck 284 in image 263, the person 288 approaching the front door in image 264, the person 290 at the door in image 265, and the person 292 moving away from the door-along with presence of an additional person 294—in image 266. However, a condition field 330 of record 217 does not indicate presence of a condition in the form of a person. Accordingly, the time 16:00 246 of the record 216 preceding record 217 is determined to be an end time 332 of the event (as represented with a dashed-line outline around the record 216 in FIG. 3). Having determined the start time 306 and the end time 332, a period extending from the start time 306 to the end time 332 is identified as the event 334 (as represented by the bracket in FIG. 3).

As previously described, the image 263, identified as the first image 310 representing the start of an event, was retrieved from the rolling buffer 124 and transmitted to the client device 150. The transmission of the first image 310 to the client device 150 signals to the user 152 a detection of the event 334 (e.g., an on-going event). In implementations, the monitoring device 102 further identifies second media (e.g., a second image). The second image may be, for example, a key frame that is representative of the event 334 (e.g., an event-climax snapshot). In additional implementations, the second image may be a composite image of one or more captured images (e.g., a combination of several images into one representative image). In still further implementations, the monitoring device can identify multiple images with interest scores above a threshold and produce, in lieu of the single second image, an animation (e.g., a low frame per second (fps) animation, a low-resolution animation). The monitoring device 102 may transmit the second media (e.g., the second image) to a remote device (e.g., remote device 132), such as a server. Thus, if the user 152 wishes to view further information about the event 334, the user 152 can view the second media via access to the remote device. In various implementations, the second image is selected by identifying a record within the event 334 having the highest interest score.

In the example of FIGS. 2 and 3, record 213 has the highest interest score 336, which is 8. (As previously stated, values of the interest scores 308 and 336 are chosen purely to show relative values based on status of the conditions logged in the records 207-216.) The time 13.00 1243 of the record 213 is thus determined to be a peak time 338 (as represented by the record 213 being surrounded by a solid-line outline in FIG. 3). In various implementations, the monitoring device 102 then retrieves from the rolling buffer 124 an image captured in a second temporal proximity to the peak time 338. The image captured within the second temporal proximity of the peak time 338 and thus may present an event-climax snapshot of the event 334. The image 265 captured at time 12.50 275 is closest in time to the peak time 338 and, thus, is flagged as a second image 340 (represented by the image 265 being surrounded with a dotted-and-dashed line outline in FIG. 3). The second image 340 (or an image derived from the second image 340 as described below with reference to FIG. 5D) is made available to the user 152 as described below with reference to FIGS. 4 and 5C-5D.

FIG. 4 shows a system 400 similar to the system 100 of FIG. 1 in which an alert and images of the event of FIGS. 2 and 3 have been transmitted to, or have otherwise been made available to, the user 152 via the client device 150. The monitoring device 102 is configured to transmit one or more sets of data to the remote device 132 to inform the user 152 of the event 334.

As previously described, the monitoring device 102 may be configured to send the start image 310 (the image 263) to the client device 150 to inform the user 152 of the occurrence of the event 334. In various implementations, the first image 310 is pushed directly to the client device 150 (e.g., a mobile telephone used by the user 152) to notify the user 152 of the start of the event 334.) In additional implementations, the remote device 132 of the system 400, upon receiving the first image 310, may send a text or email to the user 152 to forward the first image 310 or a link to the first image 310, which may be stored at the remote device 132. In still further implementations, a web-based application operating on the client device 150, via access to the remote device 132 and/or the monitoring device 102, can be instructed to present a notification, including the first image 310. It will be appreciated that the client device 150 may receive a notification 402, as further described with reference to FIG. 5A, that the user 152 may select to view the first image 310. Sending the notification 402 may be preferable to directly posting the first image 310 on the display 154 of the client device 150 for the sake of privacy and/or to avoid interrupting a task the user 152 is performing on the client device 150.

The second image 340 (the image 265) can also be transmitted to the remote device 132 and be stored in the remote image storage 142 of the remote device 132. The user 152 can then view the second image 340 at the client device 150 via wireless connection to the remote device 132. Alternatively, the system 400 also may deliver the second image 340 directly to the client device 150 via a push notification like the first image 310. Also, the monitoring device 102 may transmit the event log 122 to the remote device 132 where the event log 133 is stored in the remote event storage 140. The user 152 may retrieve the event log 122 from the remote event storage 140 to view additional information about the event 334, for example, to determine when the event ended or how long the event lasted.

It will be appreciated that, by only sending two images to the user 152 and/or the remote device 132, less transmission bandwidth and/or data storage is used in providing information to the user 152 about the event 334, as compared to sending a video stream, for example. At the same time, by notifying the user 152 of the start of the event 334 by sending the first image 310 and providing the second image 340 to provide representative information about the event 334, the user 152 is informed of when the event 334 started and is provided some information of what occurred during the event 334.

FIGS. 5A-5D shows information that may be made available to the user 152 via the display 154 of the client device 150 (see FIGS. 1 and 4). FIG. 5A shows the notification 402 in the form of an event alert message 500 presented on the display 154 of the client device 150. As previously mentioned with reference to FIG. 4, the event alert message 500 gives the user 152 notice (which may be coupled with an alert sound or vibration, with which users of mobile devices are familiar) of the start 306 of the event 334 (see FIG. 3). As previously mentioned, presenting the event alert message 500 gives the user 152 privacy, as compared to posting the first image 310 directly onto the display 154, as well as avoids interrupting the user 152 in performing another task on the client device 150. The user 152 may open the event alert message 500, for example, by using a hand 502 to engage the event alert message 500 presented on the display 154.

FIG. 5B shows the first image 310, retrieved from the rolling buffer 124 and transmitted to the client device 150. As previously described, the first image 310 may be pushed to the client device 150 to give the user 152 notice of the event 334. The first image 310 may include the time 07.50 273 at which the first image 310 (the image 263) was captured. The first image 310 (or the event alert message 500) may be superimposed with one or more links 504 and 506 provided by an application on the client device 150 that the user 152 may engage to retrieve additional information about the event 334, such as the second image 340 or the event log 122.

FIG. 5C shows the second image 340, retrieved from the rolling buffer 124 and transmitted to the remote device 132 representative of the event 240. As previously described, in various implementations, the second image 340 is selected as having the highest interest score during the event 334 and, thus, may regarded as most representative of the event 334. As previously described with reference to FIG. 5B, the user 152 may engage one of the links 504 or 506 or otherwise engage the event alert message 500 to retrieve the second image 340 from the remote device 132 as described with reference to FIG. 4. Alternatively, the second image 340 may be pushed by the remote device 132 to the client device 150.

Alternatively, instead of sending the image 265 (FIGS. 2, 3, and 5C) as the second image 340 as representative of the event 334, the monitoring device 102 may be configured to augment the image 265 to include other conditions detected during the event 334. As previously described, in this example, persons are regarded as trigger conditions. As shown in FIGS. 3 and 4, image 266 captured during the event 334 showed presence of another person 294. The person 294 may be of interest to the user 152. For example, the user 152 may be interested to know that there were multiple persons present during the event 334, which would not be shown in the image 265. The person 290 may be known to the user 152. Alternatively, if the person 290 is a delivery person, the user 152 may be troubled that the other person 294, being present at the same time as a delivery person, might be a “porch pirate” who might take any package left by the delivery person.

Referring to FIG. 5D, in order to more fully represent the event 334, the monitoring device 102 may augment the image 265, originally selected as the second image 340, to include or to represent other conditions. Thus, for example, the monitoring device 102 may superimpose other image data captured during the event 334 so as to include the other person 294 in an augmented representative image 510. The augmented representative image 510 is not one of the images 260-268 captured by the monitoring device 102 included in FIGS. 2 and 3. Instead, the monitoring device 102 incorporates image data from other images in which computer vision employed by the monitoring device detects one or more other images in which other persons or present. The monitoring device 102, for example, may recognize that image 266 includes both the person 290 shown in image 265 and the other person 294. The monitoring device 102 thus may merge the other person 294 into the augmented representative image 510 to more fully represent conditions detected during the event 334.

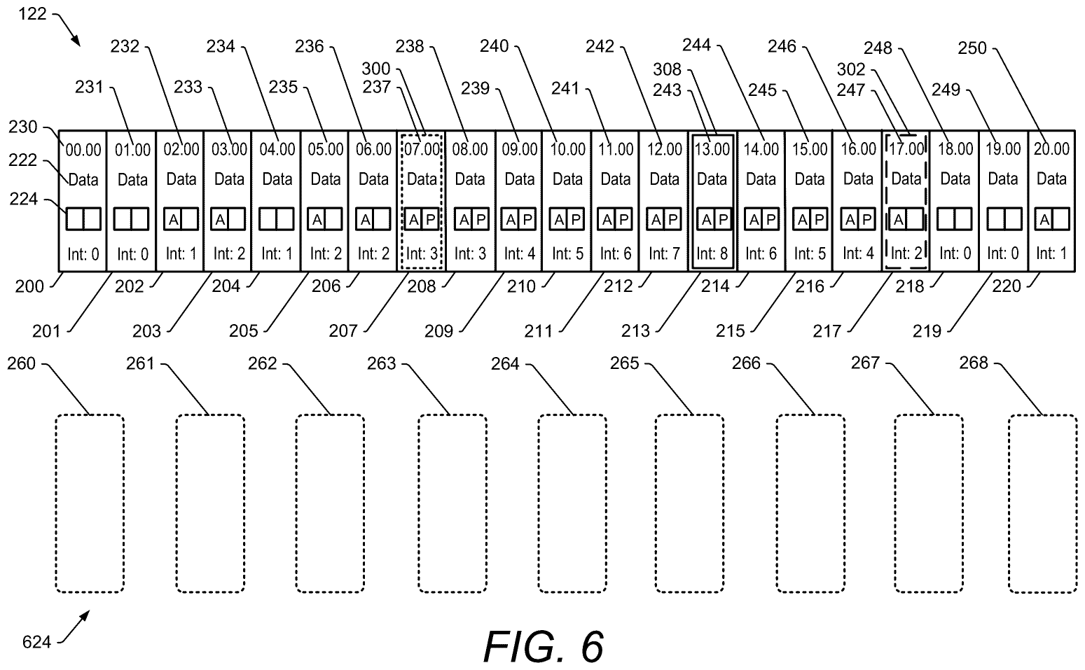

FIG. 6 shows the event log 122 and a rolling buffer 624 (e.g., rolling buffer 124) at a time after the start image 310 and the second image 340 have been sent to the user 152 and/or to the remote device 132. To save room in the data storage device 118 incorporated in the monitoring device 102, the rolling buffer 124 of FIGS. 1-4 may be periodically purged to make room for subsequent images to be captured. Alternatively, instead of purging the rolling buffer 124 periodically, the rolling buffer 124 may be purged on an as-needed basis when storage space is needed in the data storage device 118 to accommodate additional images. Accordingly, locations of the previously-stored images 260-268 are shown in dotted lines in the rolling buffer 624 to indicate that the storage previously occupied by the images 260-268 is free to store other images or other data. The event log 122 also may be purged periodically or on an as-needed basis to free up storage for other data. Alternatively, the event log 122 may be purged from the data storage device 118 after the event log 122 is transmitted to the remote device 132, as described with reference to FIG. 4.

### Example Method

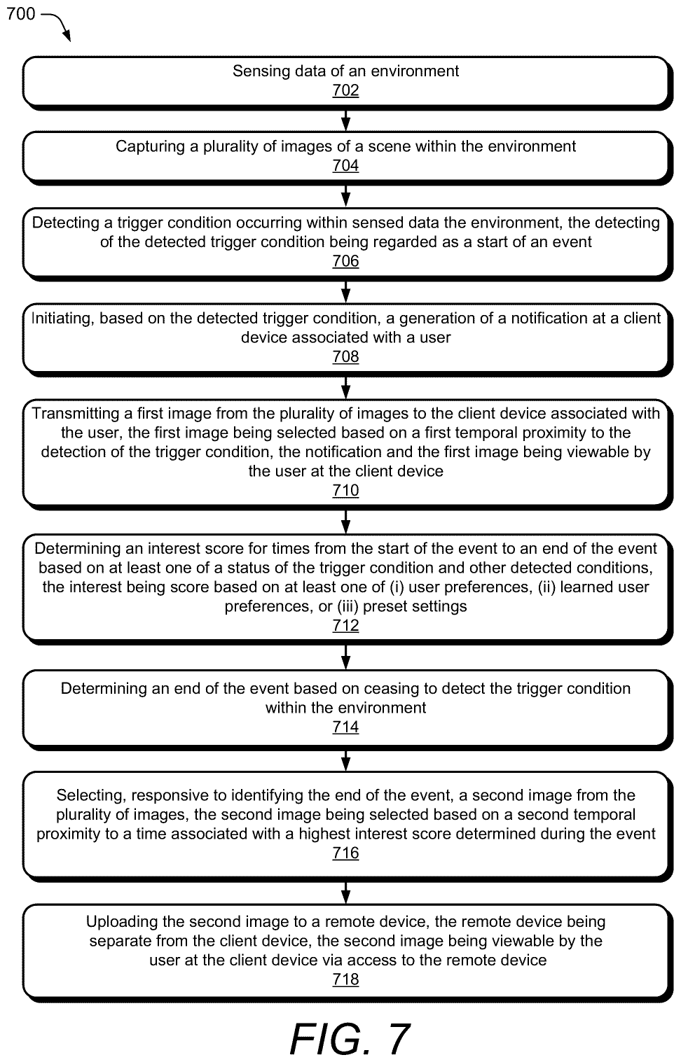

FIG. 7 is a flow diagram of an example method of sending selected images from the monitoring device 102 to a user or to a remote device as previously described with reference to FIGS. 1-6. At a block 702, data 108 is sensed in an environment 110. At a block 704, a plurality of images 260-268 are captured of a scene 112 within the environment 110. At a block 706, a trigger condition, such as the appearance of a person 286, occurring within the sensed data of the environment 110, is detected. The detecting of the trigger condition may be regarded as a start of an event 334. At a block 708, based on the detected trigger condition, a generation of a notification 402 is initiated at a client device 150 associated with a user 152. At a block 710, a first image 310 from the plurality of images 260-268 is transmitted to the client device 150 associated with the user 152, the first image 310 being selected based on a first temporal proximity to the detection of the trigger condition. The notification 402 and the first image 310 are viewable by the user 152 at the client device 150.

At a block 712, an interest score 224 is determined for a plurality of time intervals 237-246 extending from the start (e.g., start image 310) of the event 334 to an end time 332 of the event 334 based on at least one of a status of the trigger condition 286 and other detected conditions, the interest score 224 being based on at least one of (i) user settings, (ii) learned user preferences, or (iii) preset settings. At a block 714, the end time 332 of the event 334 is determined based on ceasing to detect the trigger condition 286 within the environment 110. At a block 716, responsive to identifying the end of the event, a second image 340 is selected from the plurality of images 260-268, the second image 340 being selected based on a second temporal proximity to a time 275 associated with a highest interest score 336 determined during the event 334. At a block 718, the second image 340 is uploaded to a remote device 132, the remote device 132 being separate from the client device 150. The second image 340 is viewable by the user 152 at the client device 150 via access to the remote device 132.

The preceding discussion describes systems and techniques for sending selected images from a monitoring device to a user or a remote device to reduce data transmission and storage overhead. The systems and techniques use processing resources included in the monitoring device to identify the selected images that are representative of an event identified by the monitoring device. These systems and techniques may be realized using one or more of the entities or components shown in FIGS. 1-6 and used as described with reference to FIG. 7. However, the figures illustrate only some of the many possible systems capable of employing the described techniques.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although implementations of systems and techniques for sending selected images from a monitoring device to a user or a remote device to reduce data transmission and storage overhead have been described in language specific to certain features and/or methods, the subject of the appended claims is not necessarily limited to the specific features or methods described. Rather, the specific features and methods are disclosed as example implementations of systems and techniques for sending selected images from a monitoring device to a user or a remote device to reduce data transmission and storage overhead.

What is claimed is:

1. A monitoring device comprising:
a wireless communication component configured to transmit and receive wireless communications;
one or more sensors configured to sense data of an environment surrounding the monitoring device;
one or more processors; and
a data storage device configured to store at least portions of the sensed data and one or more programs, the one or more programs to be executed by the one or more processors, the one or more programs comprising instructions for:
detecting, based on the sensed data, a trigger condition, the trigger condition indicative of a start of an event occurring within the environment surrounding the monitoring device;
initiating, based on the detected trigger condition, a generation of a notification at a client device associated with a monitoring device user;
selecting first media from the sensed data based on a first temporal proximity to the detection of the trigger condition;
transmitting the first media to the client device associated with the monitoring device user, the notification and the first media being viewable at a display of the client device;
determining an interest score at a plurality of time intervals, the plurality of time intervals extending from the start of the event to an end of the event;
selecting, at the end of the event, second media from the sensed data, the second media being selected based on a second temporal proximity to a respective time interval of the plurality of time intervals associated with a high interest score determined during the event; and
uploading the second media to a remote device, the remote device being separate from the client device, the second media being viewable at the client device via access to the remote device.

2. The monitoring device of claim 1, wherein the trigger condition is one of a plurality of conditions detectable in the sensed data by the monitoring device.

3. The monitoring device of claim 2, wherein one or more of the plurality of conditions are selectable as a trigger condition based on at least one of (i) user preferences, (ii) machine-learned user preferences, or (iii) preset settings.

4. The monitoring device of claim 2, wherein the one or more sensors comprise a microphone, and wherein the plurality of conditions include an audio event.

5. The monitoring device of claim 1, wherein the monitoring device and the environment are associated with a smarthome environment, and wherein the monitoring device is configured to receive additional sensed data from one or more additional sensors operatively coupled to the monitoring device.

6. The monitoring device of claim 1, wherein the one or more sensors comprise an image sensor configured to capture a plurality of images, and wherein the sensed data comprises a plurality of images.

7. The monitoring device of claim 6, wherein:
the selected first media comprises a first image selected from the plurality of images; and
the second media comprises one or more additional images selected from the plurality of images.

8. The monitoring device of claim 7, wherein the one or more additional images comprise a composite image based on two or more images of the plurality of images.

9. The monitoring device of claim 7, wherein the one or more additional images comprise an animation, the animation composed of low-resolution images or non-consecutive images.

10. A computer-readable storage medium comprising instructions that, when executed, configure at least one processor to:
detect, based on sensed data, a trigger condition, the trigger condition indicative of a start of an event occurring within an environment surrounding a monitoring device;
initiate, based on the detected trigger condition, a generation of a notification at a client device associated with a monitoring device user;
select first media from the sensed data based on a first temporal proximity to the detection of the trigger condition;
transmit the first media to the client device associated with the monitoring device user, the notification and the first media being viewable at a display of the client device;
determine an interest score at a plurality of time intervals, the plurality of time intervals extending from the start of the event to an end of the event;
select, at the end of the event, second media from the sensed data, the second media being selected based on a second temporal proximity to a respective time interval of the plurality of time intervals associated with a high interest score determined during the event; and
upload the second media to a remote device, the remote device being separate from the client device, the second media being viewable at the client device via access to the remote device.

11. The computer-readable storage medium of claim 10, wherein the trigger condition is one of a plurality of conditions detectable in the sensed data by the monitoring device.

12. The computer-readable storage medium of claim 11, wherein one or more of the plurality of conditions are selectable as a trigger condition based on at least one of (i) user preferences, (ii) machine-learned user preferences, or (iii) preset settings.

13. The computer-readable storage medium of claim 11, wherein the instructions, when executed, further configure the at least one processor to:
receive audio data from one or more sensors, and wherein the plurality of conditions include an audio event.

14. The computer-readable storage medium of claim 10, wherein the monitoring device and the environment are associated with a smarthome environment, and wherein the instructions, when executed, further configure the at least one processor to:
receive additional sensed data from one or more sensors operatively coupled to the monitoring device.

15. The computer-readable storage medium of claim 10, wherein the instructions, when executed, further configure the at least one processor to:
receive a plurality of images from at least one image sensor, and wherein the sensed data comprises a plurality of images.

16. The computer-readable storage medium of claim 15, wherein:
the selected first media comprises a first image selected from the plurality of images; and
the second media comprises one or more additional images selected from the plurality of images.

17. The computer-readable storage medium of claim 16, wherein the one or more additional images comprise a composite image based on two or more images of the plurality of images.

18. The computer-readable storage medium of claim 16, wherein the one or more additional images comprise an animation, the animation composed of low-resolution images or non-consecutive images.

19. The computer-readable storage medium of claim 10, wherein the interest score is determined based on at least one of contextual information, types of detected objects, a confidence of detected objects or events, or a machine-learned technique for key frame detection.

20. The computer-readable storage medium of claim 19, wherein the instructions, when executed, further configure the at least one processor to:
adjust interest score sensitivity based on instructions from the client device associated with the monitoring device user.
